(19) United States
(12) Patent Application Publication
(10) Pub. No.: US 2004/0247987 A1
(43) Pub. Date: Dec. 9, 2004

(54) Fuel cell

(75) Inventors: Masahiko Izumi, Niiza-shi (JP); Nozomu Yamaguchi, Wako-shi (JP)

Correspondence Address: LAHIVE & COCKFIELD, LLP., 28 STATE STREET, BOSTON, MA, 02109, US

(73) Assignee: Honda Motor Co., Ltd., Tokyo (JP)

(21) Appl. No.: 10/863,033

(22) Filed: Jun. 7, 2004

(30) Foreign Application Priority Data
Jun. 5, 2003 (JP) 2003-161290

(51) Int. Cl. H01M 8/02; H01M 4/86

(52) U.S. Cl. 429/38; 429/40; 429/37

(57) ABSTRACT

A fuel cell includes an electrolyte electrode assembly including a cathode, and an anode, and an electrolyte interposed between the cathode and the anode. The separator includes a pair of plates. A fuel gas channel and an oxygen-containing gas channels are formed separately between the plates. The anode of the electrolyte electrode assembly includes a porous layer, and pores in the porous layer are connected to form a fuel gas supply passage. A fuel gas inlet is formed on the plate of the separator. A fuel gas from the fuel gas channel is supplied to a central region of the anode through the fuel gas inlet.

### BACKGROUND OF THE INVENTION

1. Field of the Invention

The present invention relates to a fuel cell having an electrolyte electrode assembly including an anode, a cathode, and an electrolyte interposed between the anode and the cathode. The electrolyte electrode assembly is interposed between separators.

2. Description of the Related Art

Typically, a solid oxide fuel cell (SOFC) employs an electrolyte of ion-conductive solid oxide such as stabilized zirconia. The electrolyte is interposed between an anode and a cathode to form an electrolyte electrode assembly. The electrolyte electrode assembly is interposed between separators (bipolar plates), and the electrolyte electrode assembly and the separators make up a unit of fuel cell for generating electricity. A predetermined number of fuel cells are stacked together to form a fuel cell stack.

In the fuel cell, an oxygen-containing gas or air is supplied to the cathode. The oxygen in the oxygen-containing gas is ionized at the interface between the anode and the electrolyte, and the oxygen ions (O²⁻) move toward the anode through the electrolyte. A fuel gas such as hydrogen-containing gas or CO is supplied to the anode. Oxygen ions react with the hydrogen in the hydrogen-containing gas to produce H₂O or react with CO to produce CO₂. Electrons released in the reaction flow through an external circuit to the cathode, creating a DC electric current.

In the fuel cell, it is desirable to improve fuel utilization ratio. For example, in an attempt to improve the fuel utilization ratio, U.S. Pat. No. 6,361,892 discloses a fuel cell including a separator in contact with electrodes. Specifically, as shown in FIG. 25, the fuel cell 1 is formed by stacking four layers, i.e., a separator 2, a cathode layer 3, an electrolyte 4, and an anode layer 5. A fuel manifold 6 extends through a central region of the fuel cell 1 in the stacking direction. Further, two air manifolds 7 extend through the fuel cell 1. The fuel manifold 6 is positioned between the air manifolds 7.

A large number of micro channels 8 are defined in the anode layer 5 along the surface of the separator 2. The micro channels 8 are formed by a plurality of posts (columns) 9 constituting the anode layer 5. The height of the columns 9 is short to form the low micro channels 8. The fuel gas is efficiently supplied through the low micro channels 8.

In the fuel cell disclosed in U.S. Pat. No. 6,361,892, the pattern of the micro channels 8 is fabricated by screen printing, photolithography, pressing, calendering, or the like. Fabrication of the micro channels 8 using these techniques is rather complicated. Therefore, the production cost of the anode layer 5 is high.

### SUMMARY OF THE INVENTION

A general object of the present invention is to provide a fuel cell having a simple and economical structure in which utilization ratio of a fuel gas is improved, and power generation can be carried out efficiently.

According to the present invention, an anode of the fuel cell includes a porous layer having internal pores connected to form a fuel gas supply passage. The separator has a fuel gas inlet for supplying a fuel gas to a central region of the anode from a fuel gas channel.

The pores of the porous layer are arranged irregularly in the anode. The fuel gas flowing through the pores of the anode contacts the catalyst layer of the anode for a long, sufficient time. Therefore, the reaction of fuel gas occurs efficiently. The fuel gas is supplied radially outwardly from the central region toward the outer circumferential region of the anode in the fuel gas supply passage.

Therefore, the fuel gas is uniformly distributed to the electrode catalyst layer of the anode, and the power generation can be carried out uniformly over the entire electrolyte electrode assembly. The anode can be fabricated by the conventional screen printing. Therefore, the fuel cell can be produced at a low cost.

The separator may include first and second plates stacked together. The fuel gas channel and the oxygen-containing gas channel are formed separately between the first and second plates. Therefore, the fuel cell is thin, having a small dimension in the stacking direction.

Further, the first plate may face the cathode of the electrolyte electrode assembly provided on one side of the separator. The second plate is tightly in contact with the anode of the electrolyte electrode assembly provided on the other side of the separator. The fuel gas inlet is formed on said second plate.

Thus, the fuel gas supplied to the central region of the anode through the fuel gas inlet is diffused to the fuel gas supply passage in the anode, and flows outwardly toward the outer circumferential region of the anode. Some of the fuel gas may flow through the gaps between the plate and the anode. However, since the fuel gas flows outwardly from the central region to the outer circumferential region of the anode, the fuel gas is distributed on the entire surface of the anode uniformly.

The second plate may have a plurality of dimples for forming recesses between the second plate and the anode of the electrolyte electrode assembly. Thus, when the flow rate or the pressure of the fuel gas flowing through the fuel gas supply passage increases, some of the fuel gas flows into the dimples. Therefore, the flow rate or the pressure is suitable regulated by the function of the dimples. Simply by providing the dimples, the fuel gas is reliably supplied radially outwardly from the central region to the outer circumferential region of the anode.

Further, a protrusion protruding toward the second plate may be formed in a surface of the first plate. The protrusion is tightly in contact with the second plate such that the second plate is tightly in contact with the anode. With the simple structure, the second plate and the anode are tightly in contact with each other. The utilization ratio of the fuel gas is improved greatly.

Further, the protrusion may be a folded piece formed by cutting part of the surface of the first plate. The folded piece is not affected by the overall rigidity of the separator. For example, the folded piece is not affected by distortion of the separator. The folded piece is capable of applying a force to tighten the second plate and anode together.

Alternatively, the protrusion may be a boss which is formed by deforming part of the surface of the first plate. The emboss section including bosses is fabricated simply. With the simple process, the second plate and the anode can be tightened together.

Further, a tightening force applying mechanism may be provided for applying a tightening force on opposite ends of a stack body formed by stacking the electrolyte electrode assembly and the separators such that the electrolyte electrode assembly and the separators are tightened together, and the second plate and the anode are tightly in contact with each other. Therefore, the separators can be tightened reliably regardless of the shapes of the separators. The tightening force applying mechanism is applicable to various shapes of the fuel cells.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view schematically showing a fuel cell stack formed by stacking a plurality of fuel cells according to a first embodiment of the present invention;

FIG. 2 is a cross sectional view showing part of a fuel cell system in which the fuel cell stack is provided in a casing;

FIG. 3 is a view schematically showing a gas turbine using the fuel cell stacks;

FIG. 4 is an exploded perspective view of the fuel cell;

FIG. 5 is a perspective view showing part of the fuel cell and operation of the fuel cell;

FIG. 6 is an exploded perspective view showing a separator of the fuel cell;

FIG. 7 is an enlarged front view showing part of a plate of the separator;

FIG. 8 is a cross sectional view, with a partial omission, of the fuel cell;

FIG. 9 is a perspective view showing folded pieces of the separator;

FIG. 10 is an enlarged front view showing part of the other plate of the separator;

FIG. 11 is an enlarged cross sectional view showing a central region of the fuel cell;

FIG. 12 is an enlarged cross sectional view showing an outer circumferential region of the fuel cell;

FIG. 13 is a cross sectional view schematically showing operation of the fuel cell;

FIG. 14 is an exploded perspective view showing a fuel cell according to a second embodiment of the present invention;

FIG. 15 is an exploded perspective view of a separator of a fuel cell according to a third embodiment of the present invention;

FIG. 16 is a view showing operation of a fuel cell according to a fourth embodiment of the present invention;

FIG. 17 is an exploded perspective view showing part of the fuel cell, and operation of the fuel cell;

FIG. 18 is an enlarged front view showing part of a plate of a separator of the fuel cell;

FIG. 19 is an exploded perspective view showing a fuel cell according to a fifth embodiment of the present invention;

FIG. 20 is an exploded perspective view showing a separator of the fuel cell;

FIG. 21 is an exploded perspective view showing a fuel cell according to a sixth embodiment of the present invention;

FIG. 22 is a cross sectional view, with partial omission, of a fuel cell according to a seventh embodiment of the present invention;

FIG. 23 is a cross sectional view, with partial omission, of a fuel cell according to an eighth embodiment of the present invention;

FIG. 24 is a cross sectional view, with partial omission, of a fuel cell according to an ninth embodiment of the present invention; and

FIG. 25 is a cross sectional view showing a fuel cell disclosed in U.S. Pat. No. 6,361,892.

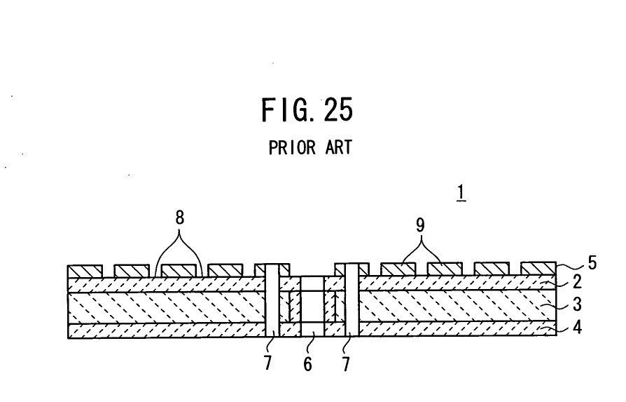

### DESCRIPTION OF THE PREFERRED EMBODIMENTS

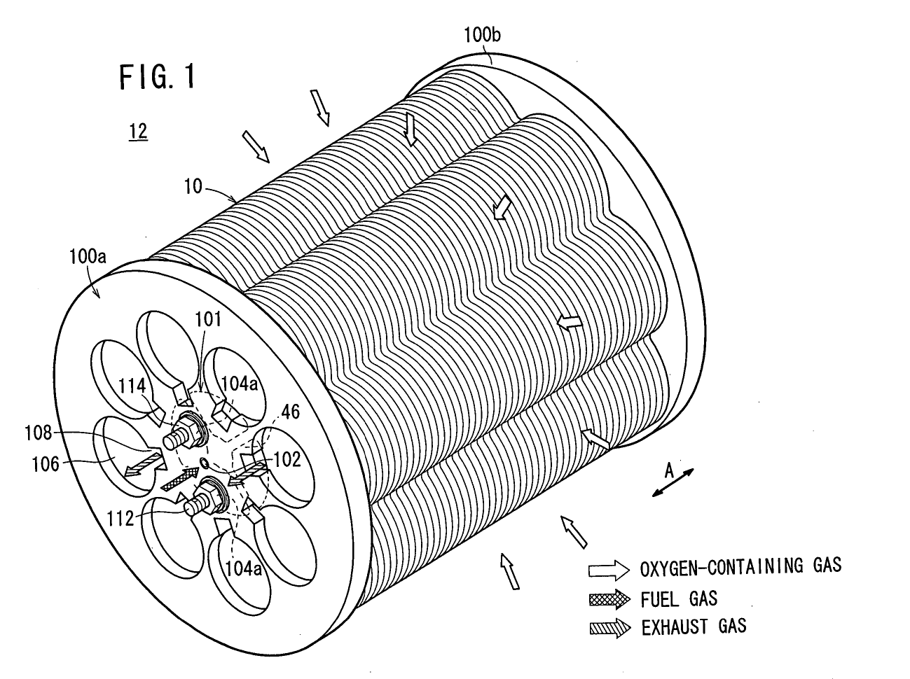

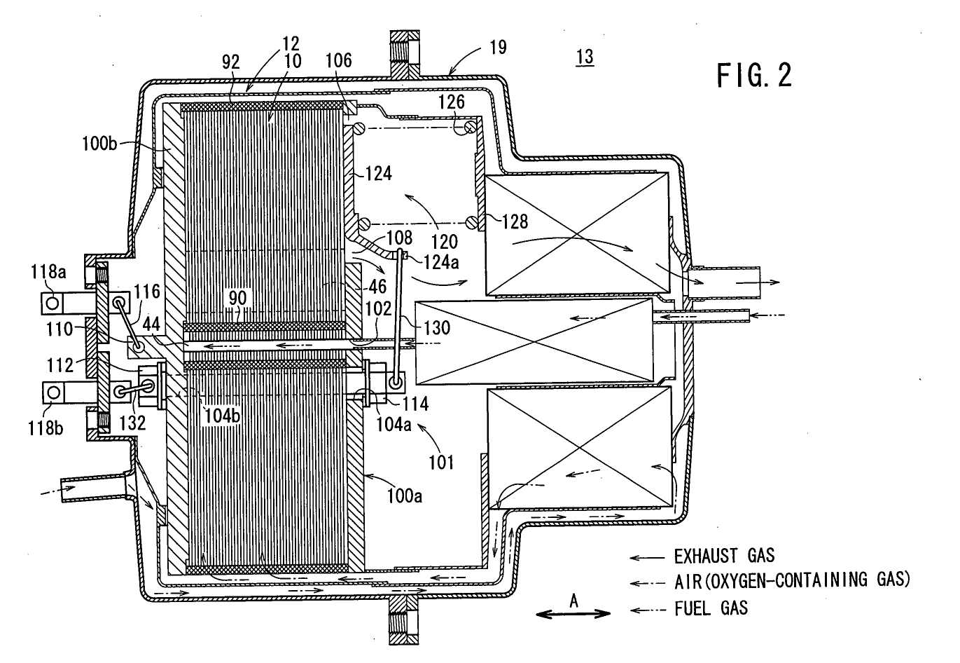

FIG. 1 is a perspective view schematically showing a fuel cell stack 12 formed by stacking a plurality of fuel cells 10 according to a first embodiment of the present invention. FIG. 2 is a cross sectional view showing part of a fuel cell system 13 in which the fuel cell stack 12 is provided in a casing 19.

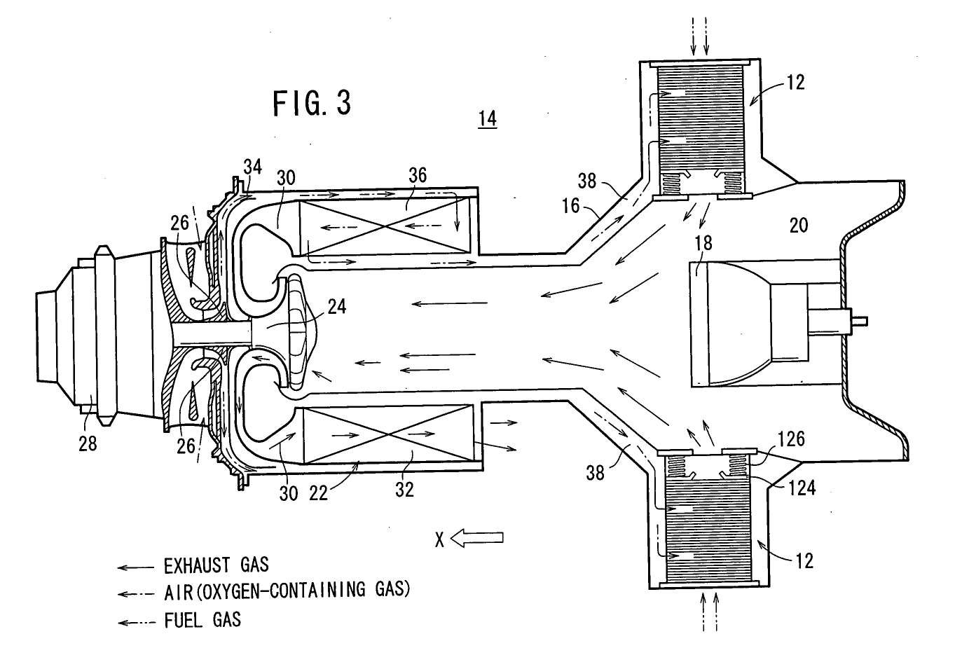

The fuel cell 10 is a solid oxide fuel cell (SOFC) for stationary and mobile applications. For example, the fuel cell 10 is mounted on vehicles. In an example of the first embodiment shown in FIG. 2, the fuel cell stack 12 is used in the fuel cell system 13. In another example shown in FIG. 3, the fuel cell stack 12 is used in a gas turbine 14.

A plurality of fuel cell stacks 12 are placed in the gas turbine 14. For example, eight fuel cell stacks 12 are provided around a combustor 18 at intervals of 450 in the casing 16. The fuel cell stack 12 discharges an exhaust gas as a mixed gas of a fuel gas and an oxygen-containing gas after reaction into a chamber 20 toward the combustor 18. The chamber 20 is narrowed in a flow direction of the exhaust gas indicated by an arrow X in FIG. 3. A heat exchanger 22 is externally provided around the chamber 20 at a forward end in the flow direction. Further, a turbine (power turbine) 24 is disposed at the forward end of the chamber 20. A compressor 26 and a power generator 28 are coaxially connected to the turbine 24. The gas turbine 14 has an axially symmetrical structure as a whole.

A discharge passage 30 of the turbine 24 is connected to a first passage 32 of the heat exchanger 22. A supply passage 34 of the compressor 26 is connected to a second passage 36 of the heat exchanger 22. The air is supplied to the outer circumferential surfaces of the fuel cell stacks 12 through a hot air inlet passage 38 connected to the second passage 36.

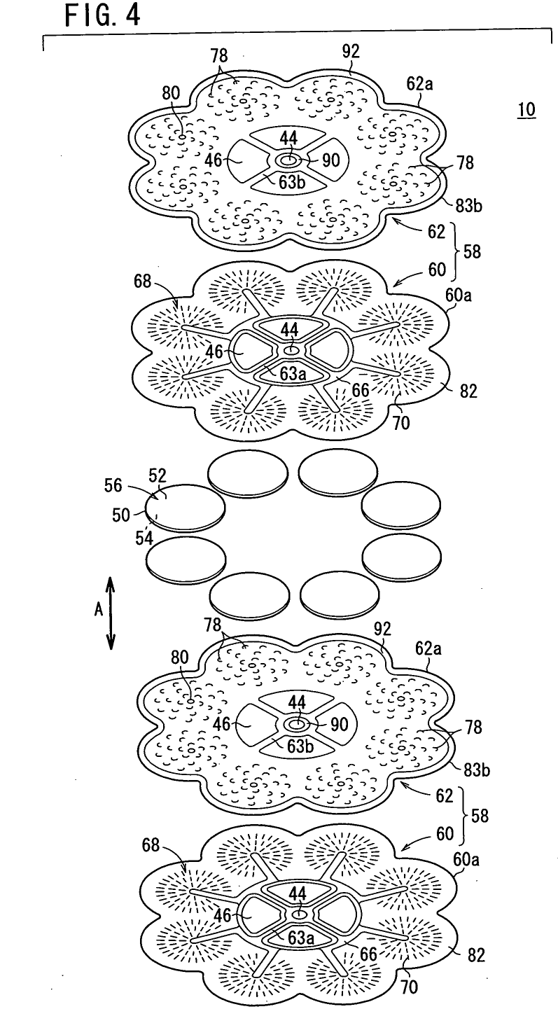

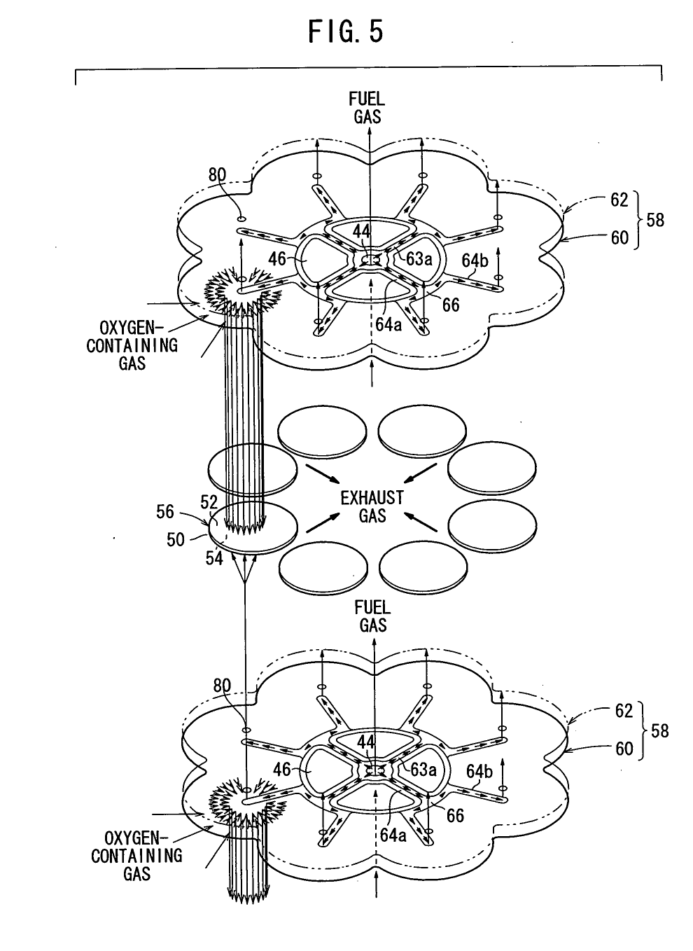

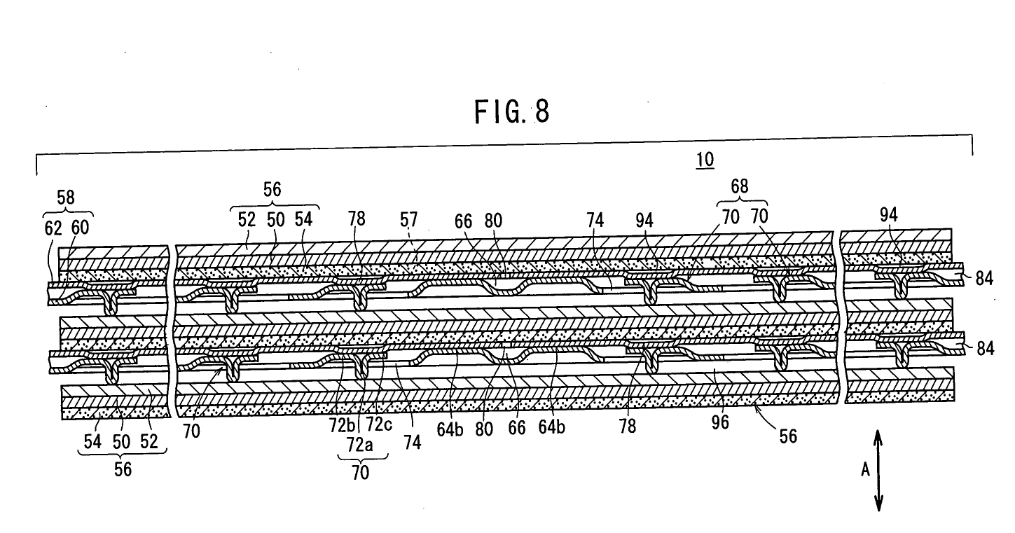

As shown in FIGS. 4 and 5, the fuel cell 10 includes electrolyte electrode assemblies 56. Each of the electrolyte electrode assemblies 56 includes a cathode 52, an anode 54, and an electrolyte (electrolyte plate) 50 interposed between the cathode 52 and the anode 54. The electrolyte 50 is formed of an ion-conductive solid oxide such as stabilized zirconia. The electrolyte electrode assembly 56 has a relatively small circular disk shape. The anode 54 is made of porous material. The anode 54 has a porosity in the range of 20% to 50%, for example. Preferably, the anode 54 has a porosity in the range of 30% to 45%. Pores in the anode 54 are connected to form a fuel gas supply passage 57 (see FIG. 8).

If the porosity of the anode 54 is less than 20%, the consumed fuel gas after reaction for power generation is not smoothly replaced by the fresh gas newly supplied to the anode 54. Thus, the fuel gas concentration may not be uniform in the surface of the anode 54. Namely, the fuel gas concentration is low at some part of the surface of the anode 54. Consequently, the desired power generation efficiency can not be achieved.

If the porosity of the anode 54 is greater than 50%, the strength of the anode 54 is not good. The electrolyte electrode assembly 56 may be damaged undesirably when a pressure load for tightening the fuel cell 10 is applied to the anode 54, or when heat stress is applied to the anode 54. The anode 54 having high porosity has a hollow structure. When electrons generated in power generation concentrate in the hollow anode 54, the current density becomes high. The resistance of the anode 54 is high, and the electrical conductivity of the anode 54 is low.

A plurality of (e.g., eight) electrolyte electrode assemblies 56 are interposed between a pair of separators 58 to form the fuel cell 10. The electrolyte electrode assemblies 56 are concentric with a fuel gas supply hole 44 formed at the center of the separators 58.

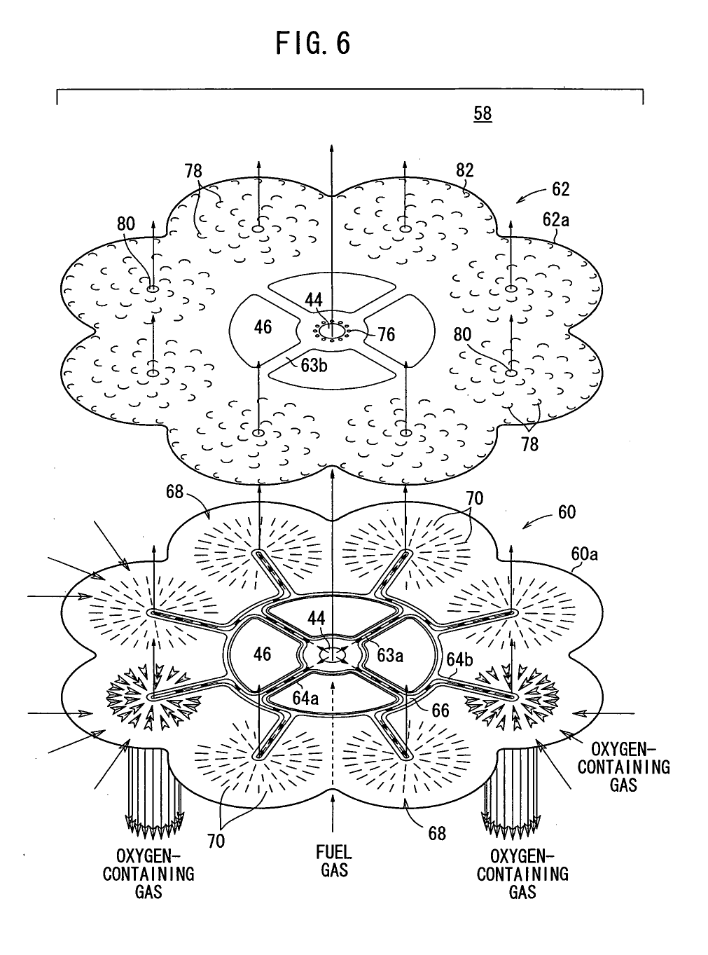

Each of the separators 58 includes a plurality of (e.g., two) plates 60, 62 which are stacked together. Each of the plates 60, 62 is formed of a stainless alloy, for example. Curved outer sections 60a, 62a are formed on the plates 60, 62, respectively (see FIGS. 4 and 6).

As shown in FIGS. 4 through 6, ribs 63a are provided around the center of the plate (first plate) 60 to form the fuel gas supply hole 44 and the four discharge passages 46. The plate 60 has four inner ridges 64a around the respective discharge passages 46. The inner ridges 64a protrude toward the plate (second plate) 62.

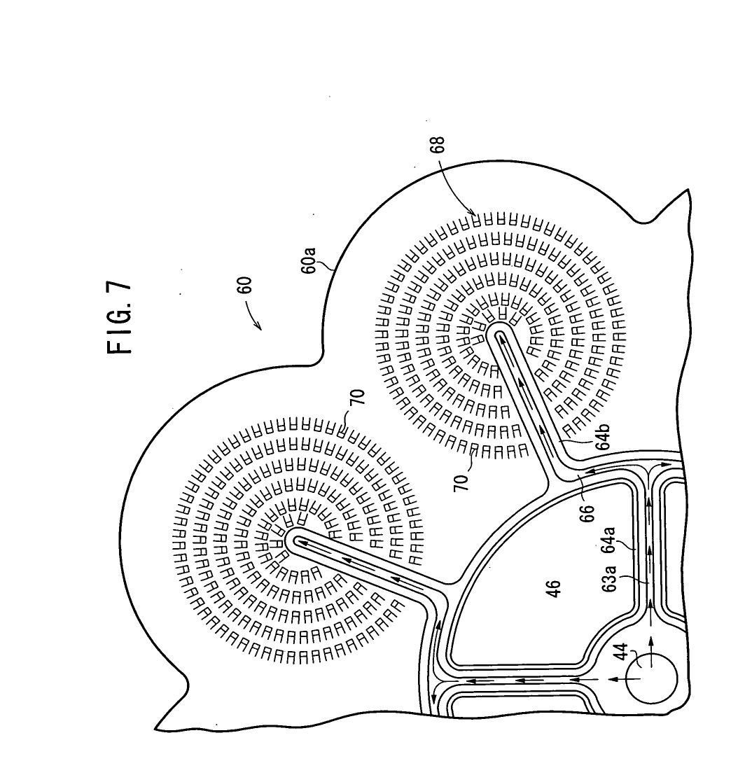

Two outer ridges 64b are connected to adjacent two inner ridges 64a. The outer ridges 64b extend radially outwardly on the plate 60. A fuel gas channel 66 is formed between the inner ridges 64a and the outer ridges 64b (see FIG. 7). Each of the outer ridges 64b extends to a virtual line passing through centers of the eight electrolyte electrode assemblies 56.

Protruding sections, e.g., folded sections 68 are provided on the plate 60 along the virtual line at positions of the eight electrolyte electrode assemblies 56. The shape of the folded section 68 corresponds to the shape of the electrolyte electrode assembly 56. A plurality of folded pieces 70 are present in each of the folded sections 68. The folded pieces 70 are formed by cutting part of the surface of the plate 60. Each of the folded pieces 70 includes a first protrusion 72a, a second protrusion 72b, and a third protrusion 72c. The first protrusion 72a protrudes away from the plate 62, and contacts the cathode 52 of the electrolyte electrode assembly 56 provided on one side of the separator 58. The second protrusion 72b protrudes toward the plate 62 from an end of the first protrusion 72a and in contact with the plate 62. The second protrusion 72a presses the plate 62 so that the plate 62 contacts the anode 54 of the electrolyte electrode assembly 56 provided on the other side of the separator 58. The third protrusion 72c protrudes from the other end of the first protrusion 72a toward the plate 62, and in contact with the plate 62 (see FIG. 8).

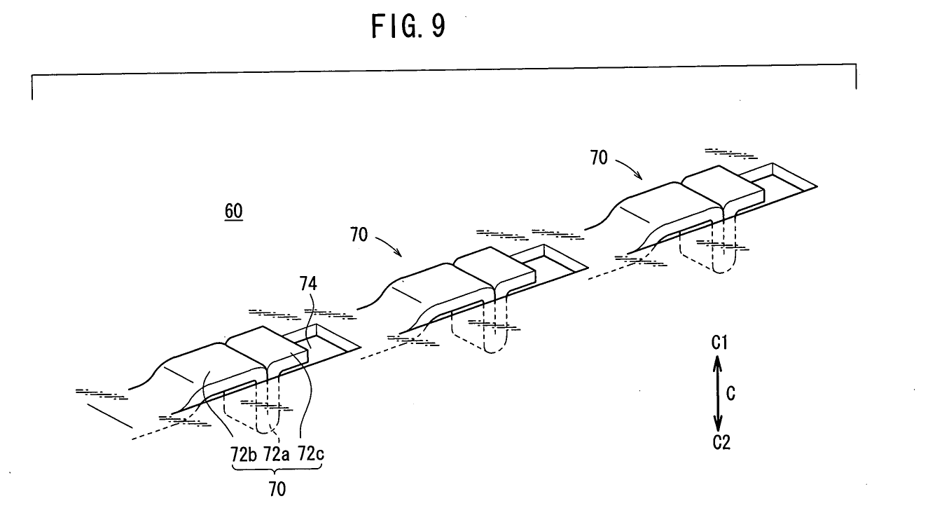

Specifically, as shown in FIG. 9, the folded piece 70 is formed by cutting the surface of the plate 60. The folded piece 70 is deformed toward the plate 62 in the direction indicated by an arrow C1 to form the second protrusion 72b. The first protrusion 72a is formed by folding the cutout portion to protrude away from the second protrusion 72b in the direction indicated by an arrow C2. The third protrusion 72c protrudes from the first protrusion 72a in the direction indicated by the arrow C1. Each of the folded pieces 70 defines a cutout opening 74 as a passage of the oxygen-containing gas.

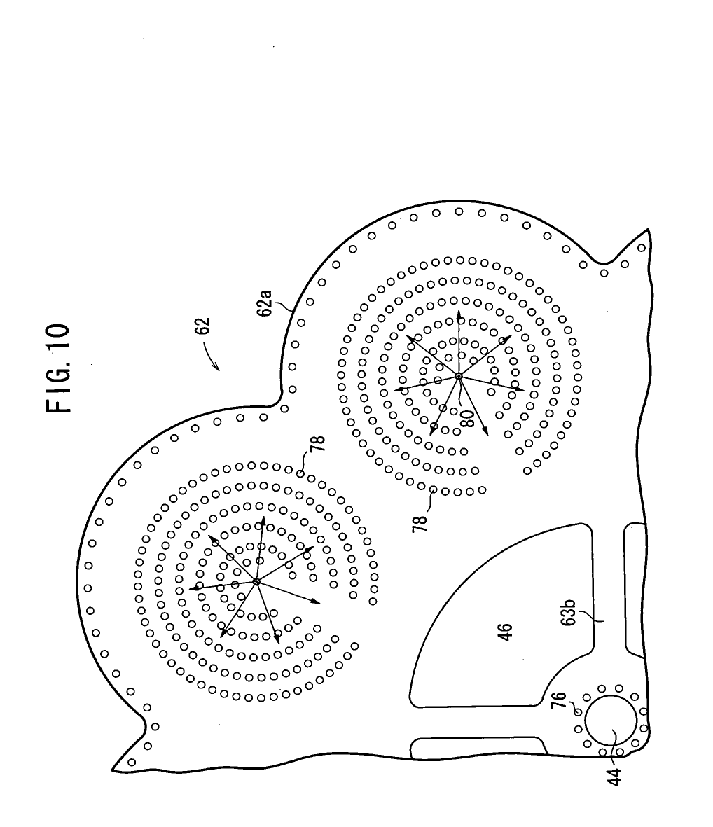

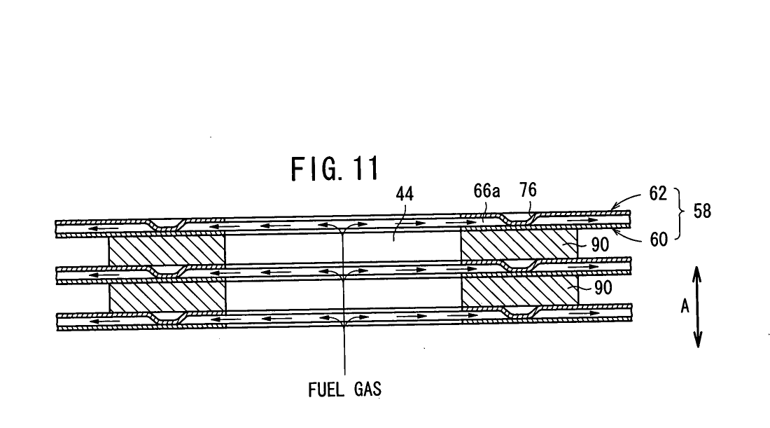

As shown in FIGS. 6 and 10, ribs 63b facing the ribs 63a are provided around the center of the plate 62. Inner recesses 76 are formed around the fuel gas supply hole 44 of the plate 62. The inner recesses 76 protrude toward the plate 60. When the plate 60 and the plate 62 are stacked together, the inner recesses 76 contact the plate 60, and a fuel gas distribution channel 66a (see FIG. 11) is formed between the plate 60 and the plate 62.

As shown in FIGS. 4, 6, and 10, a plurality of dimples (recesses) 78 are formed on the plate 62 at the positions of the respective electrolyte electrode assemblies 56 which are arranged along the virtual circle. The dimples 78 protrude away from the electrolyte electrode assembly 56. The dimples 78 are not formed in the regions where the outer ridges 64b of the plate 60 are formed.

As shown in FIG. 8, each of the dimples 78 contacts the second protrusion 72b and the third protrusion 72c of the folded piece 70. Fuel gas inlets 80 pass through the surface of the plate 62 at ends of the outer ridges 64b. The fuel gas inlets 80 are connected to the fuel gas channel 66. The fuel gas flowing through the fuel gas channel 66 is supplied through the fuel gas inlets 80 to the centers of the respective electrolyte electrode assemblies 56.

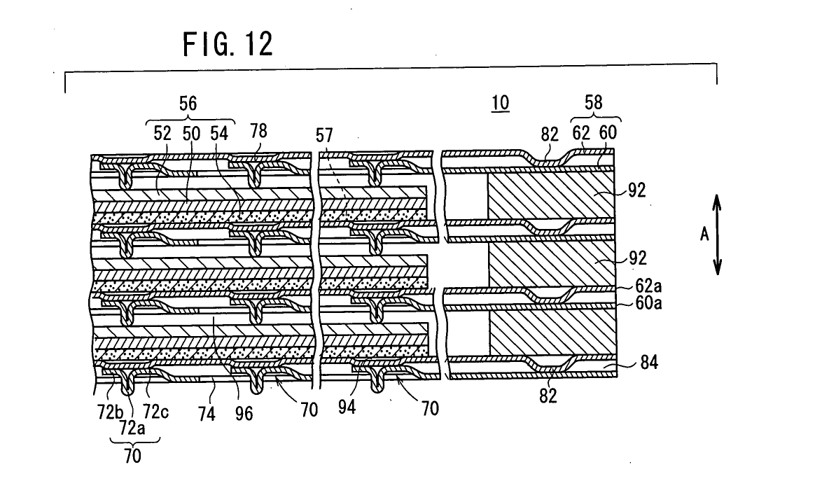

Outer recess 82 are formed along the outer curved sections 62a of the plate 62 (see FIG. 6). The outer recesses 82 protrude toward the plate 60, and contact the plate 60 to form an oxygen-containing gas channel 84 between the plate 60 and the plate 62 (see FIG. 12). The oxygen-containing gas channel 84 is connected to the cutout openings 74 on the plate 60.

As shown in FIG. 11, insulating seals 90 for sealing the fuel gas supply hole 44 are provided between the separators 58. As shown in FIG. 12, insulating seals 92 are formed between the curved outer sections 60a, 62a. For example, the insulating seal 90 is made of mica material, or ceramic material. The insulating seal 92 is made of material having low rigidity in comparison with the material of the insulating seal 90. For example, the insulating seal 92 is made of ceramic fiber.

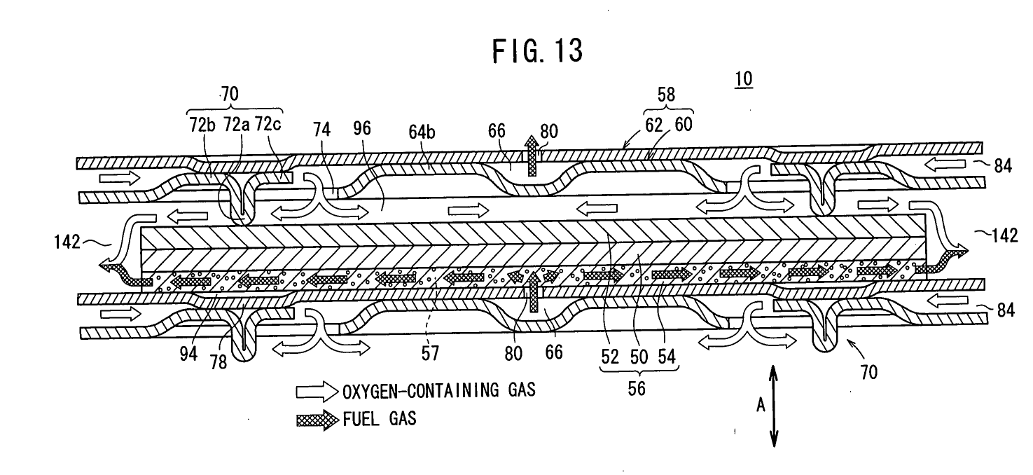

As shown in FIG. 13, the anode 54 of the electrolyte electrode assembly 56 and the plate 62 of the separator 58 are tightly in contact with each other. Each of the dimples 78 defines a gap 94. An oxygen-containing gas supply passage 96 is formed between the cathode 52 of the electrolyte electrode assembly 56 and the plate 60 of the separator 58. The opening of the oxygen-containing gas supply passage 96 has a dimension corresponding to the height of the first protrusions 72a of the respective folded pieces 70.

In each of the separators 58, the folded pieces 70 of the plate 60 contact the plate 62. Thus, the folded pieces 70 function as current collectors. The fuel cells 10 are connected in series in the direction indicated by the arrow A.

As shown in FIGS. 1 and 2, the fuel cell stack 12 includes disk shaped end plates 100a, 100b outside the outermost fuel cells 10 provided at opposite ends in the stacking direction. The fuel cells 10 are tightened together by a tightening force applying mechanism 101. The end plate 100a is insulated, and has a fuel gas supply port 102 at its central region. The fuel gas supply port 102 is connected to the fuel gas supply hole 44 for supplying the fuel gas to each of the fuel cells 10.

The end plate 100a has two bolt insertion holes 104a. The fuel gas supply port 102 is positioned between the bolt insertion holes 104a. Further, the end plate 100a has eight circular openings 106 around the fuel gas supply port 102. The circular openings 106 are arranged along the virtual line, i.e., corresponding to the respective electrolyte electrode assemblies 56. Each of the circular openings 106 is connected to a rectangular opening 108 positioned near the fuel gas supply port 102. The rectangular opening 108 partially overlaps the discharge passage 46.

The end plate 100b is made of electrically conductive material. As shown in FIG. 2, the end plate 100b has a connection terminal 110. The connection terminal 110 axially extends from the central region of the end plate 100b. Further, the end plate 100b has two bolt insertion holes 104a, 104b. The connection terminal 110 is positioned between the bolt insertion holes 104b. The bolt insertion holes 104a are in alignment with the bolt insertion holes 104b. Two bolts 112 are inserted through the bolt insertion holes 104a, 104b, and tip ends of the bolts 112 are screwed into nuts 114 to form the tightening force applying mechanism 101. The connection terminal 110 is electrically connected to an output terminal 118a, and the output terminal 118a is fixed to the casing 19.

An electrode surface tightening means 120 is provided in each of the circular openings 106 of the end plate 100a. The electrode surface tightening means 120 includes a pressing member 124 as a terminal plate which contacts the end of the fuel cell stack 12 in the stacking direction. One end of a spring 126 contacts the pressing member 124, and the other end of the spring 126 is supported by a support plate 128. The spring 126 functions to reduce the affect of heat generated in power generation, and functions as an insulator. The support plate 128 is provided in the casing 19.

Each of the pressing members 124 has an end 124a deformed in the axial direction of the fuel cell stack. The end 124a of the pressing member 124 is electrically connected to an end of the bolt 112 by a lead wire 130. The other end (head) of the bolt 112 is positioned adjacent to the connection terminal 110, and electrically connected to the output terminal 118b by a lead wire 132. The output terminal 118b is provided adjacent to, and in parallel with the output terminal 118a. The output terminal 118b is fixed to the casing 19.

Next, operation of the fuel cell stack 12 will be described below.

In assembling the fuel cell 10, the plate 60 and the plate 62 are connected together to form the separator 58. The ring shaped insulating seal 90 is provided on the plate 60 or the plate 62 around the fuel gas supply hole 44. The curved insulating seal 92 are provided on the curved outer section 60a of the plate 60 or the curved outer section 62a of the plate 62.

The fuel gas channel 66 and the oxygen-containing gas channel 84 are formed between the plates 60, 62 (see FIGS. 8 and 13). The fuel gas channel 66 is connected to the fuel gas supply hole 44 through the fuel gas distribution channel 66a, and the oxygen-containing gas channel 84 between the curved outer section 60a and the curved outer section 62a is open to the outside.

Then, the electrolyte electrode assemblies 56 are sandwiched between a pair of separators 58. As shown in FIGS. 4 and 5, the plate 60 of the one separator 58 faces the plate 62 of the other separator 58. Eight electrolyte electrode assemblies 56 are interposed between the plate 60 of the one separator 58 and the plate 62 of the other separator 58. Therefore, as shown in FIG. 13, the oxygen-containing gas supply passage 96 is formed between the cathode 52 of the electrolyte electrode assembly 56 and the plate 60. The oxygen-containing gas supply passage 96 is connected to the oxygen-containing gas channel 84 through the cutout openings 74.

The anode 54 of the electrolyte electrode assembly 56 is tightly in contact with the plate 62. A fuel gas supply passage 57 is formed in the anode 54. The fuel gas supply passage 57 is connected to the fuel gas channel 66 through the fuel gas inlet port 80. An exhaust gas passage 142 is formed between the separators 58 for guiding the exhaust gas (mixed gas of the fuel gas and the oxygen-containing gas after reaction) to the discharge passages 46.

The fuel cells 10 as assemble above are stacked in the direction indicated by the arrow A to form the fuel cell stack 12 (see FIG. 1). The fuel cell stack 12 is tightened by the tightening force applying mechanism 101 in the stacking direction. For example, as shown in FIG. 2, the fuel cell stack 12 is attached to the casing 19 using the electrode surface tightening means 120.

The fuel gas such as a hydrogen-containing gas is supplied to the fuel gas supply hole 44 from the fuel gas supply port 102 of the end plate 100a, and the oxygen-containing gas such as air is supplied from the outside of the fuel cell stack 12 under pressure. The fuel gas supplied to the fuel gas supply hole 44 flows in the stacking direction indicated by the arrow A, and is supplied to the fuel gas channel 66 through the fuel gas distribution channel 66a formed in each of the separators 58 of the fuel cells 10 (see FIG. 11). As shown in FIGS. 5 and 6, the fuel gas flows through the fuel gas channel 66 along the outer ridges 64b, and supplied into the fuel gas inlets 80. The fuel gas inlets 80 are formed at end portions of the outer ridges 64b, i.e., at positions corresponding to central regions of the anodes 54 of the electrolyte electrode assemblies 56. The fuel gas is supplied outwardly from the central regions to the outer circumferential regions of the anodes 54 (see FIG. 13).

The oxygen-containing gas is supplied to each of the fuel cells 10 from the outside. The oxygen-containing gas is supplied to the oxygen-containing gas channel 84 formed in each of the separators 58, between the plate 60 and the plate 62. The oxygen-containing gas supplied to the oxygen-containing gas channel 84 flows into the oxygen-containing gas flow passage 96 through the cutout openings 74, and flows outwardly from central regions of the cathodes 52 of the electrolyte electrode assemblies 56 (see FIGS. 5 and 13). Thus, the oxygen-containing gas is supplied to the entire surfaces of the cathodes 52 uniformly.

Therefore, in each of the electrolyte electrode assemblies 56, the fuel gas is supplied to the central region of the anode 54, and flows outwardly toward the outer circumferential region of the anode 54. Similarly, the oxygen-containing gas is supplied to the central region of the cathode 52, and flows outwardly toward the outer circumferential region of the cathode 52. The oxygen-ion passes from the cathode 52 to the anode 54 through the electrolyte 50 to generate electricity by electrochemical reactions.

The fuel cells 10 stacked in the direction indicated by the arrow A are electrically connected in series. As shown in FIG. 2, at one end of the fuel cell stack 12, the electrically conductive end plate 110b has the connection terminal 110. The connection terminal 110 is connected to the output terminal 118a through the wire 116. The other end of the fuel cell stack 12 is connected to the output terminal 118b through the pressing member 124 and the bolt 112 of the electrode surface tightening means 120. Electricity generated in the fuel cell stack 12 can be outputted from the output terminals 118a, 118b.

A plurality of electrolyte electrode assemblies 56 are sandwiched between the separators 58. Therefore, even if some of the electrolyte electrode assemblies 56 have power failures, the fuel cell stack 12 can be energized by the other electrolyte electrode assemblies 56. The power generation can be performed reliably.

After reaction of the fuel gas and the oxygen-containing gas, the fuel gas and the oxygen-gas are mixed at the outer circumferential regions of the electrolyte electrode assemblies 56. The exhaust gas (mixed gas of the fuel gas and the oxygen-containing gas after reaction) flows through the exhaust gas passage 142 formed between the separators 58, and moves toward the center of the separators 58. The exhaust gas flows into the four discharge passages 46 formed near the center of separators 58 as an exhaust gas manifold, and is discharged from the discharge passages 46 to the outside.

In the first embodiment, as shown in FIG. 8, the anode 54 is made of porous material, and pores in the porous layer of the anode 54 are connected to form the fuel gas flow passage 57. The plate 62 of the separator has the fuel gas inlets 80 for supplying the fuel gas into the central region of the anode 54 through the fuel gas channel 66.

The pores of the porous layer are arranged irregularly in the anode 54. The fuel gas flowing through the pores of the anode 54 contacts the catalyst layer of the anode 54 for a long, sufficient time. Therefore, the reaction of fuel gas occurs efficiently. The fuel gas is supplied radially outwardly from the central region toward the outer circumferential region of the anode 54 in the fuel gas supply passage 57.

Therefore, the fuel gas is distributed uniformly over the catalyst layer of the anode 54. Power generation can be carried out reliably in the entire electrolyte electrode assembly 56, and the utilization ratio of the fuel gas is improved. The anode 54 can be formed by conventional screen printing. Therefore, the fuel cell 10 can be produced at a low cost.

The separator 58 includes plates 60, 62 which are stacked together. The fuel gas channel 66 and the oxygen-containing gas channel 84 are formed separately between the plates 60, 62. Therefore, the fuel cell 10 is thin, having a small dimension in the stacking direction.

The plate 62 is tightly in contact with the anodes 54 of the electrolyte electrode assemblies 56. The plate 62 has the fuel gas inlets 80. Thus, the fuel gas supplied to the central regions of the anodes 54 through the fuel gas inlets 80 is diffused to the fuel gas supply passage 57 in the anodes 54, and flows outwardly toward the outer circumferential regions of the anodes 54. Some of the fuel gas may flow through the gaps between the plate 62 and the anode 54. However, since the fuel gas flows outwardly from the central regions to the outer circumferential regions of the anodes 54, the fuel gas is distributed on the entire surfaces of the anodes 54 uniformly.

Further, the plate 62 has the dimples 78 for forming recesses between the anode 54 of the electrolyte electrode assembly 56 and the plate 62. Thus, when the flow rate or the pressure of the fuel gas flowing through the fuel gas supply passage 57 increases, some of the fuel gas flows into the dimples 78. Therefore, the flow rate or the pressure is suitable regulated by the function of the dimples 78. Simply by providing the dimples 78, the fuel gas is reliably supplied radially outwardly from the central region to the outer circumferential region of the anode 54.

The folded pieces 70 are formed by cutting the surface of the plate 60. As shown in FIGS. 8 and 13, the folded pieces 70 include the first protrusion 72a which protrudes away from the plate 62 and contacts the cathode 52 of the electrolyte electrode assembly 56 provided on one side of the separator 58, and the second and third protrusions 72b, 72c which protrude toward the plate 62, and contact the plate 62. The second and third protrusions 72b, 72c press the plate 62 so that the plate 62 contacts the anode 54 of the electrolyte electrode assembly 56 provided on the other side of the separator 58. With the simple structure, the plate 62 is reliably in contact with the anode 54. Therefore, the utilization ratio of the fuel gas is greatly improved.

A tightening force is applied by the tightening force applying mechanism 101 to the opposite ends of the fuel cell stack 12 formed by stacking the electrolyte electrode assembles 56 and the separators 58. Therefore, the separators 58 can be tightened reliably regardless of the shapes of the separators 58. The tightening force applying mechanism 101 is applicable to various shapes of the fuel cells 10.

In the first embodiment, the plate 60 of the separator 58 contacts the cathode 52 of the electrolyte electrode assembly 56 on one side, and the plate 62 of the separator 58 contacts the anode 54 of the membrane electrode assembly 56 on the other side. Alternatively, the plate 60 of the separator 58 may contact the anode 54, and the plate 62 of the separator 58 may contact the cathode 52.

Instead of using the folded sections 68, emboss sections may be used. Bosses of the emboss sections can be produced easily. Thus, the production process is simplified. With the simplified structure, the bosses can be used for suitably tightening the components of the fuel cell stack 12.

Next, operation of the fuel cell stack 12 used in the gas turbine 14 shown in FIG. 3 will be described briefly.

As shown in FIG. 3, in starting the operation of the gas turbine 14, the combustor 18 is energized to spin the turbine 24, and energize the compressor 26 and the power generator 28. The compressor 26 functions to guide the external air into the supply passage 34. The air is pressurized and heated to a predetermined temperature (e.g., 200° C.), and supplied to the second passage 36 of the heat exchanger 22.

A hot exhaust gas as a mixed gas of the fuel gas and the oxygen-containing gas after reaction is supplied to the first passage 32 of the heat exchanger 22 for heating the air supplied to the second passage 36 of the heat exchanger 22. The heated air flows through the hot air supply passage 38, and supplied to the fuel cells 10 of the fuel cell stack 12 from the outside. Thus, the power generation is performed by the fuel cells 10, and the exhaust gas generated by the reaction of the fuel gas and the oxygen-containing gas is discharged into the chamber 20 in the casing 16.

At this time, the temperature of the exhaust gas discharged from the fuel cells (solid oxide fuel cells) 10 is high, in the range of 800° C. to 1000° C. The exhaust gas spins the turbine 24 for generating electricity by the power generator 28. The exhaust gas is supplied to the heat exchanger 22 for heating the external air. Therefore, it is not necessary to use the combustor 18 for spinning the turbine 24.

The hot exhaust gas in the range of 800° C. to 1000° C. can be used for internally reforming a fuel supplied to the fuel cell stack 12. Therefore, various fuels such as natural gas, butane, and gasoline can be used for the internal reforming.

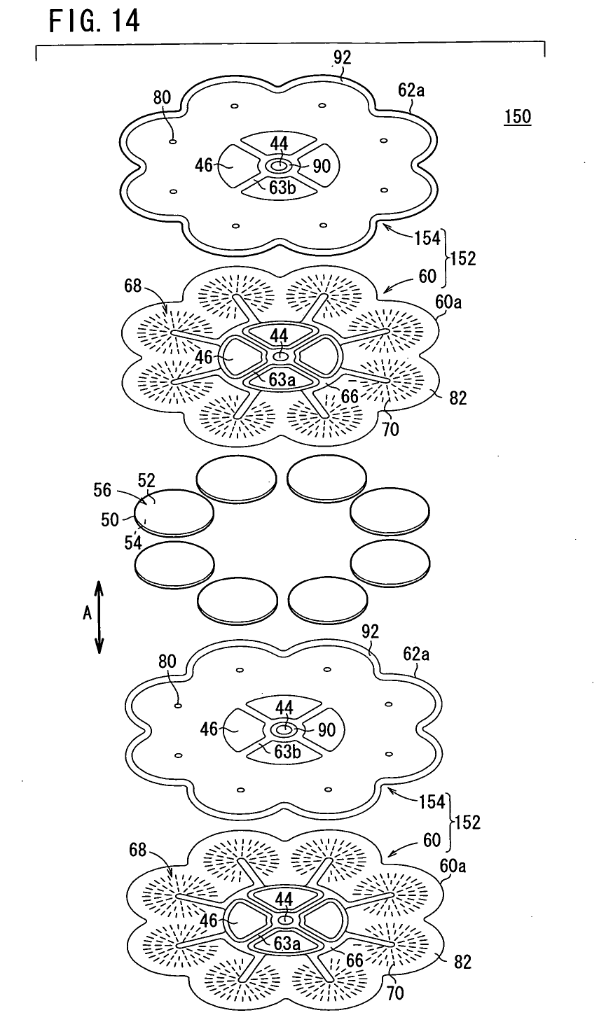

FIG. 14 is an exploded perspective view showing a fuel cell 150 according to a second embodiment of the present invention. The constituent elements that are identical to those of the fuel cell 10 according to the first embodiment are labeled with the same reference numeral, and description thereof will be omitted. In third through ninth embodiments as described later, the constituent elements that are identical to those of the fuel cell 10 according to the first embodiment are labeled with the same reference numeral, and description thereof will be omitted.

The fuel cell 150 includes electrolyte electrode assemblies 56 and a pair of separators 152 sandwiching the electrolyte electrode assembly 56. For example, the separator 152 includes two plates 60, 154. No dimples are formed on the surface of the plate 154. The plate 154 has a planar shape.

In the second embodiment, a fuel gas channel 66 and an oxygen-containing gas channel 84 are formed between the plate 60, 154, and the same advantages as with the first embodiment can be obtained. When the planar plate 154 contacts the anode 54, the area of the contact between the planar plate 154 and the anode 54 is very large.

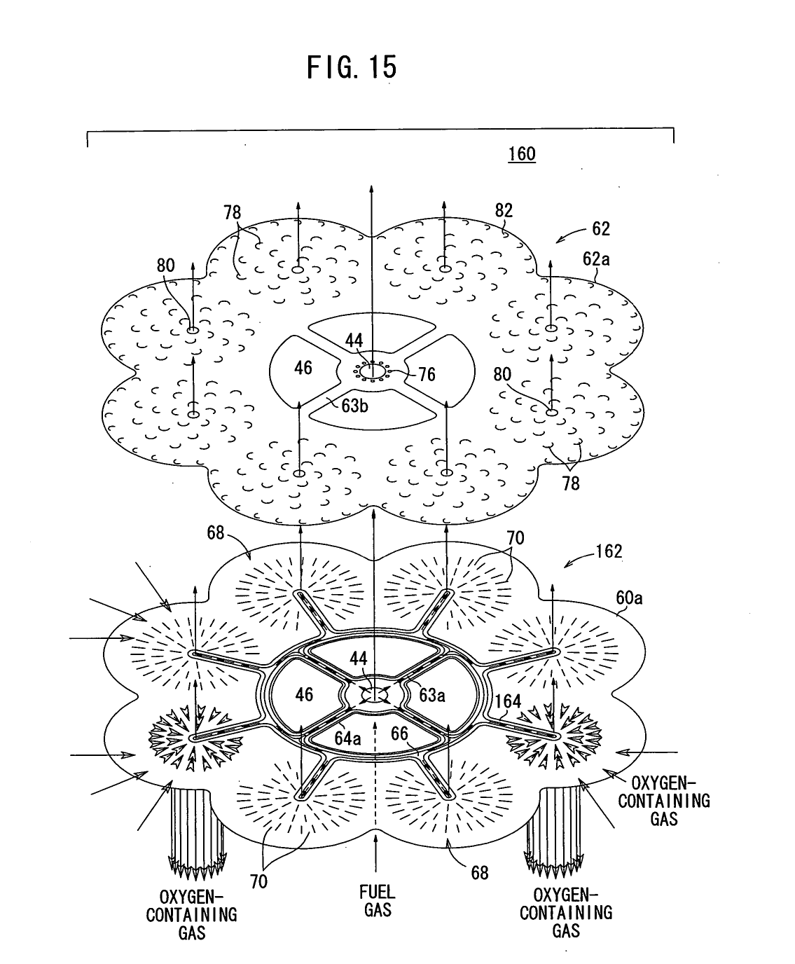

FIG. 15 is an exploded perspective view showing a separator 160 according to a third embodiment of the present invention.

The separator 160 include two plates 162, 62, for example. The plate 162 has four inner ridges 64a around respective exhaust gas passage 46. Further, the plate 162 has outer ridges 164 outside the inner ridges 64a. A fuel gas channel 66 is formed between the inner ridges 64a and the outer ridges 164.

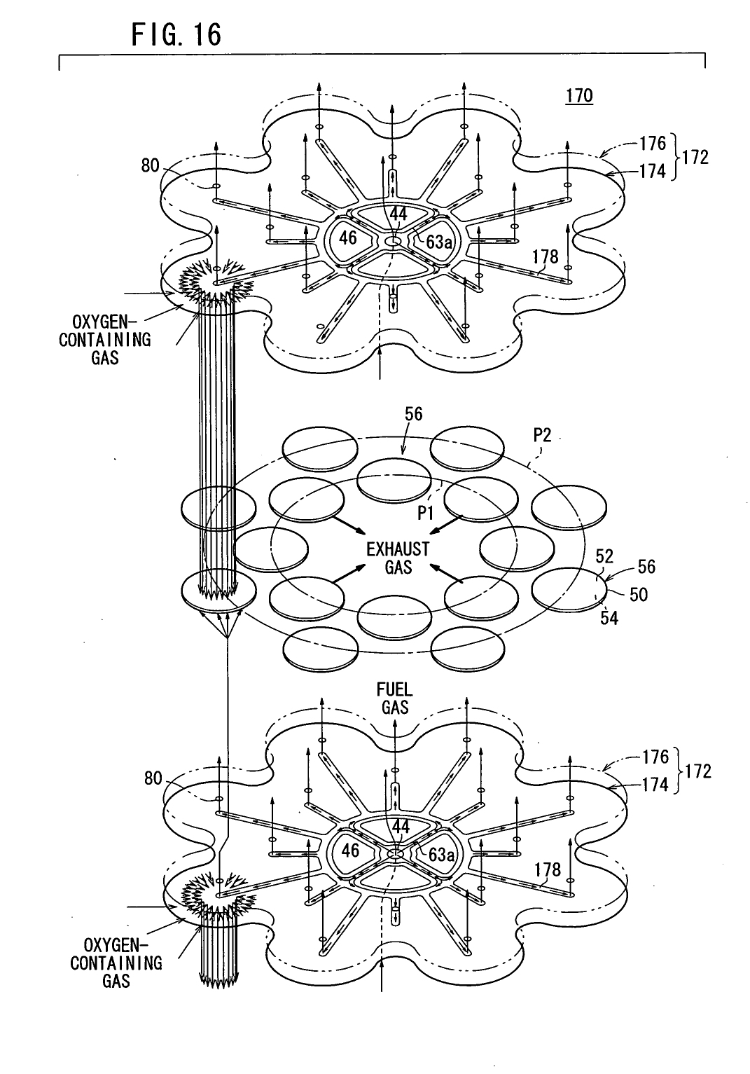

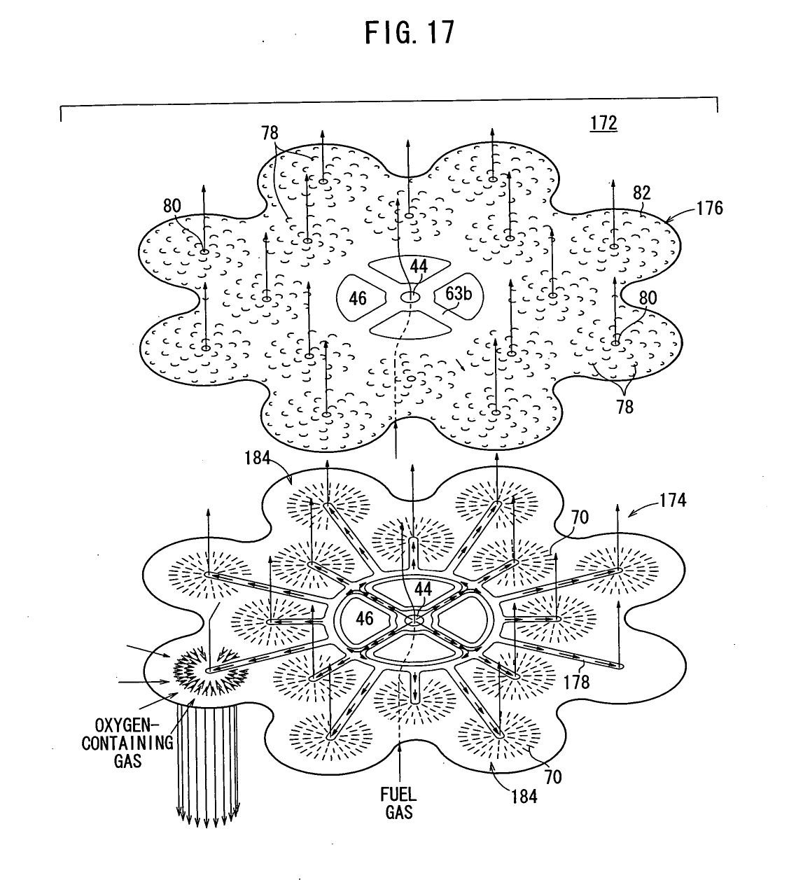

FIG. 16 is a view showing operation of a fuel cell 170 according to a fourth embodiment of the present invention, and FIG. 17 is an exploded perspective view showing part of the fuel cell 170 and operation of the fuel cell 170.

A plurality of, e.g., sixteen electrolyte electrode assemblies 56 are interposed between a pair of separators 172. Eight electrolyte electrode assemblies 56 are arranged along an inner circle P1, and eight electrolyte electrode assemblies 56 are arranged along an outer circle P2. The inner circle P1 and the outer circle P2 are concentric with a fuel gas supply hole 44 formed at the center of the separators 172 (see FIG. 16).

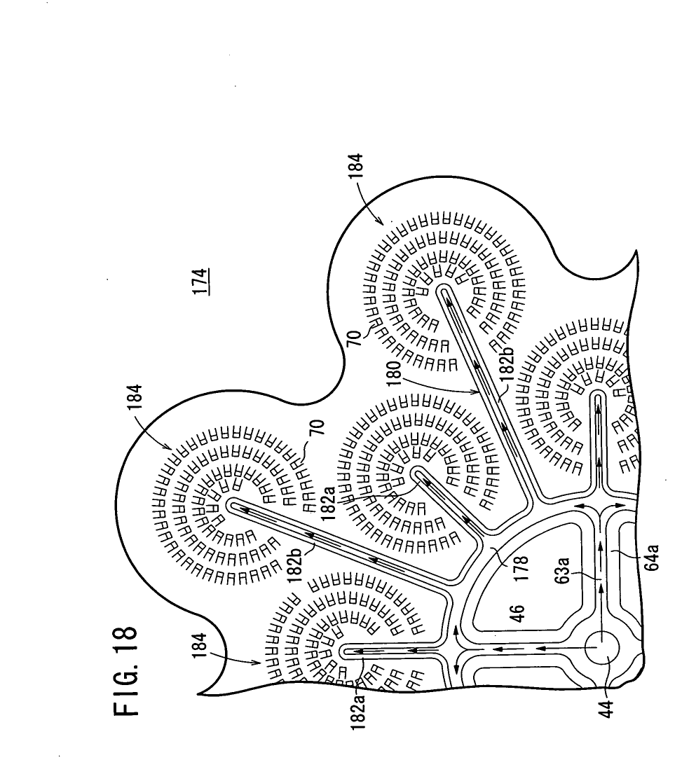

The separator 172 includes plates 174, 176. As shown in FIG. 18, the plate 174 has four inner ridges 64a around respective exhaust gas passages 46. Further, an outer ridge 180 is formed outside the inner ridges 64a. A fuel gas cannel 178 is defined between the inner ridges 64a and the outer ridge 180.

The outer ridge 180 includes a plurality of first walls 182a and second walls 182b each extending radially outwardly by a predetermined distance. The first walls 182a and the second walls 182b are formed alternately. Each of the first walls 182a extends to the inner circle P1 which is a virtual line passing through centers of eight inner electrolyte electrode assemblies 56. Each of the second walls 182b extends to the outer circle P2 which is a virtual line passing through centers of eight outer electrolyte electrode assemblies 56. The eight inner electrolyte electrode assemblies 56 are arranged along the inner circle P1, and the eight outer electrolyte electrode assemblies 56 are arranged along the outer circle P2.

The folded sections 184 are provided on the plate 174, at positions of the sixteen electrolyte electrode assemblies 56 which are arranged along the inner circle P1 and the outer circle P2, respectively. A plurality of folded pieces 70 are formed in each of the folded sections 184.

As shown in FIGS. 16 and 17, a plurality of dimples (protrusions) 78 are provided on the plate 176. The dimples 78 are provided at positions of the sixteen electrolyte electrode assemblies 56 which are arranged along the inner circle P1 and the outer circle P2, respectively. The dimples 78 protrude away from the electrolyte electrode assemblies 56. The electrolyte electrode assemblies 56 are formed around the center of the plate 176. Fuel gas inlets 80 are formed at sixteen positions at centers of the electrolyte electrode assemblies 56.

In the fourth embodiment, the same advantages as with the first embodiment can be obtained. Further, the fuel cell 170 includes the sixteen electrolyte electrode assemblies 56. Therefore, the fuel cell 170 can perform power generation at a high output.

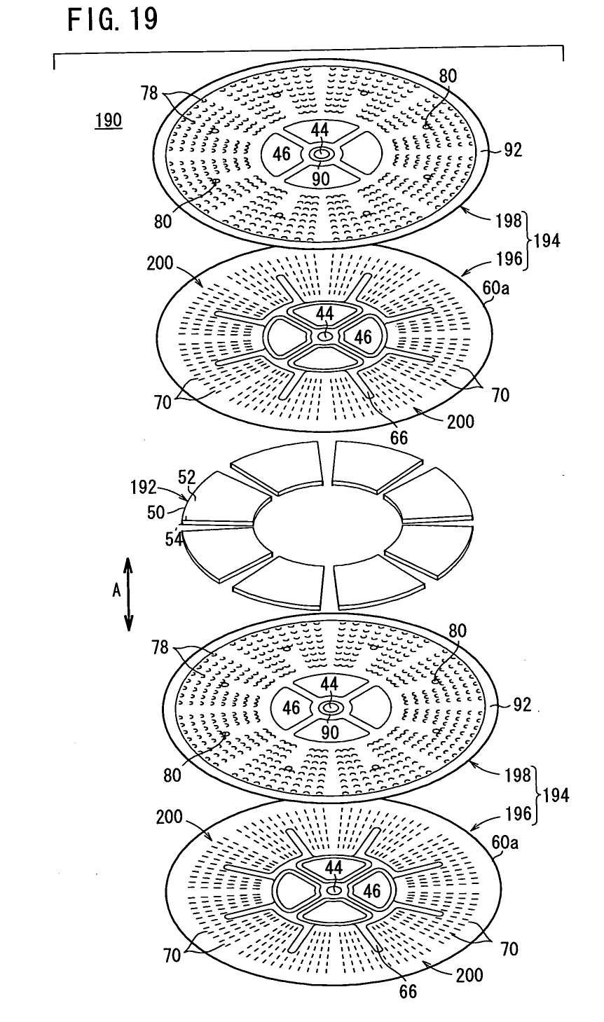

FIG. 19 is an exploded perspective view showing a fuel cell 190 according to a fifth embodiment of the present invention.

The fuel cell 190 includes an electrolyte electrode assemblies 192, and a pair of separators 194 sandwiching the electrolyte electrode assemblies 192. For example, each of the electrolyte electrode assemblies 192 has a fan shape which is formed by dividing a ring into eight pieces.

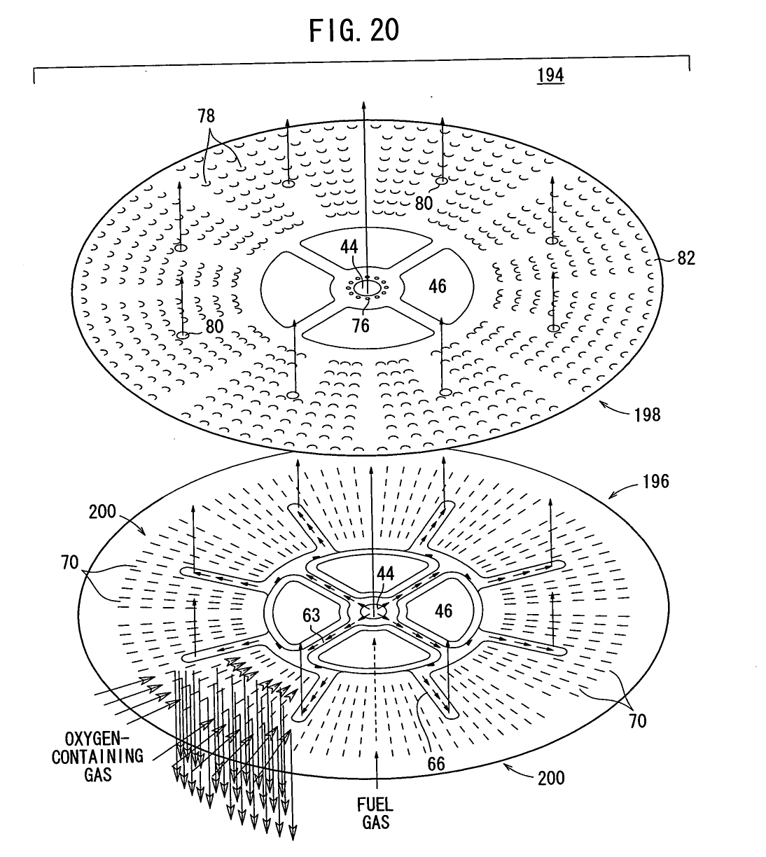

As shown in FIGS. 19 and 20, the separator 194 includes two plates 196, 198, for example. Folded sections 200 are formed on the plate 106, at eight positions corresponding to shapes of the electrolyte electrode assemblies 192. A plurality of folding pieces 70 are formed in each of the folded sections 200. The folded pieces 70 are oriented toward to the center of the plate 196. Dimples 78 are provided at eight sections corresponding to the shape of the electrolyte electrode assembly 192 on the plate 198.

In the fifth embodiment, the same advantages as with the first embodiment can be obtained. Further, the surface area of the electrolyte electrode assembly 192 used for power generation can be increased.

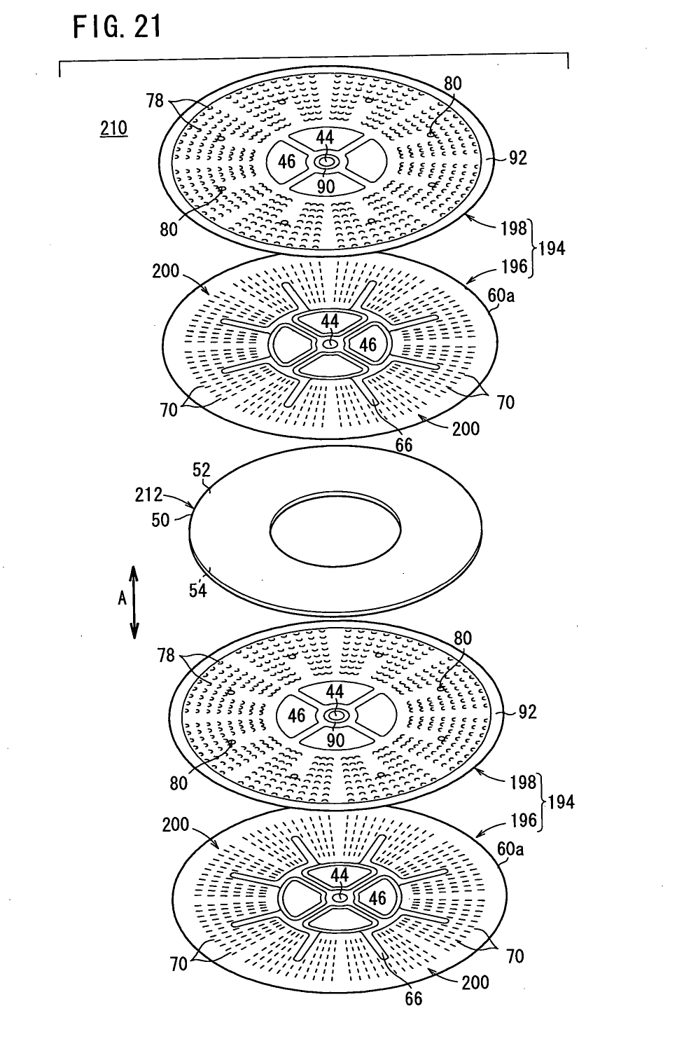

FIG. 21 is an exploded perspective view showing a fuel cell 210 according to a sixth embodiment of the present invention. The fuel cell 210 includes a ring-shaped electrolyte electrode assembly 212, and a pair of separators 194 sandwiching the electrolyte electrode assembly 212. In the sixth embodiment, the same advantages as with the fifth embodiment can be obtained.

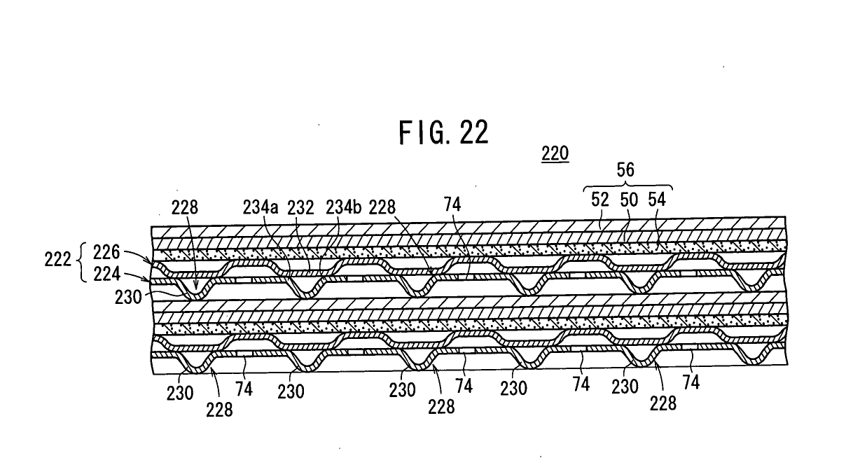

FIG. 22 is a cross sectional view, with partial omission, showing a fuel cell 220 according to a seventh embodiment of the present invention.

The fuel cell 220 includes an electrolyte electrode assembly 56 and a pair of separators 222 sandwiching the electrolyte electrode assembly 56. The separator 222 includes plates 224, 226. A plurality of folded pieces 228 are formed on the plate 224. Each of the folded pieces 228 has a protrusion 230 which protrudes away from the plate 226, and contacts the cathode 52. The width of the protrusion 230 is large in comparison with the first protrusion 72a of the first embodiment, and the rigidity of the protrusion 230 is small in comparison with the first protrusion 72a.

A plurality of dimples (protrusions) 232 are formed on the plate 226. The dimples 232 protrude toward the plate 224. The depth of the dimples 232 is large in contrast with the dimples 78 of the first embodiment. The dimples 232 contact shoulders 234a, 234b, and have the desired rigidity.

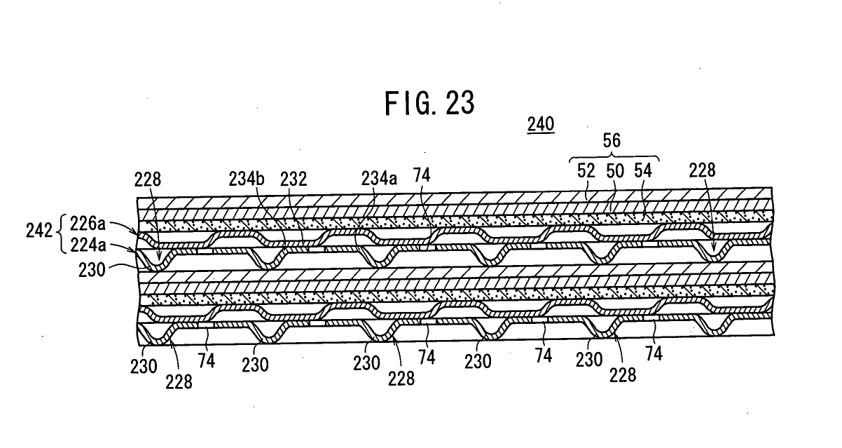

FIG. 23 is a cross sectional view, with partial omission, of a fuel cell 240 according to an eighth embodiment of the present invention.

The separator 242 of the fuel cell 240 includes plates 224a, 226a. The folded piece 228 of the plate 224a is displaced from the position of the dimple 232 of the plate 226a. Therefore, only the shoulder 234b of the protrusion 230 contacts the dimple 232, and the rigidity of the separator 242 is small in comparison with the separator 222 of the seventh embodiment.

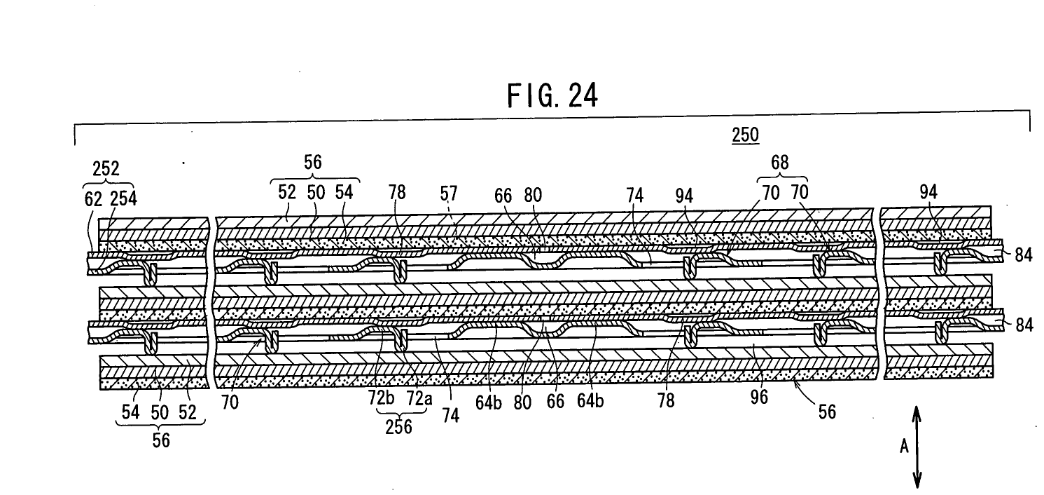

FIG. 24 is a cross sectional view, with partial omission, of a fuel cell 250 according to a ninth embodiment of the present invention.

The separator 252 of the fuel cell 250 includes a plate 254 and 62. The plate 254 has folded pieces 256. The folded piece 256 has a first protrusion 72a and a second protrusion 72b. An end of the first protrusion 72a is folded back from the cathode 52 toward the dimple 78, but does not contact the dimple 78.

Therefore, in the ninth embodiment, the first protrusion 72a contacts the cathode 52, and only the second protrusion 72b contacts the dimple 78 of the plate 62. In comparison with the first embodiment, the rigidity of the separator 252 is small.

In the seventh through ninth embodiment, the dimples 232, and 78 of the plate 226, 226a, 62 are not essential. The plates 226, 226a, 62 may have a planar shape. Various configurations of the separator can be selectively adopted to achieve the desired rigidity of the separator.

The invention has been particularly shown and described with reference to preferred embodiments, it will be understood that variations and modifications can be effected thereto by those skilled in the art without departing from the spirit and scope of the invention as defined by the appended claims.

What is claimed is:

1. A fuel cell comprising an electrolyte electrode assembly and a pair of separators sandwiching said electrolyte electrode assembly, said electrolyte electrode assembly including an anode, a cathode, and an electrolyte interposed between said anode and said cathode,
wherein a fuel gas is supplied through a fuel gas channel to said anode, and an oxygen-containing gas is supplied through an oxygen-containing gas channel to said cathode;
said anode includes a porous layer having internal pores connected to form a fuel gas supply passage; and
said separator has a fuel gas inlet for supplying said fuel gas to a central region of said anode from said fuel gas channel.

2. A fuel cell according to claim 1, wherein said separator includes first and second plates stacked together, and said fuel gas channel and said oxygen-containing gas channel are formed separately between said first and second plates.

3. A fuel cell according to claim 2, wherein said first plate faces said cathode of said electrolyte electrode assembly;
said second plate is tightly in contact with said anode of said electrolyte electrode assembly; and
said fuel gas inlet is formed on said second plate.

4. A fuel cell according to claim 3, wherein said second plate has a plurality of dimples for forming recesses between said second plate and said anode of said electrolyte electrode assembly.

5. A fuel cell according to claim 3, wherein a protrusion protruding toward said second plate is formed in a surface of said first plate; and
said protrusion is tightly in contact with said second plate such that said second plate is tightly in contact with said anode.

6. A fuel cell according to claim 5, wherein said protrusion is a folded piece formed by cutting part of said surface of said first plate.

7. A fuel cell according to claim 6, wherein said folded piece includes another protrusion which protrudes in a direction opposite to said protrusion, and contacts said cathode.

8. A fuel cell according to claim 5, wherein said protrusion is a boss as part of said surface of said first plate.

9. A fuel cell according to claim 1, further including a tightening force applying mechanism for applying a tightening force on opposite ends of a stack body formed by stacking said electrolyte electrode assembly and said separators such that said electrolyte electrode assembly and said separators are tightened together, and said second plate and said anode are tightly in contact with each other.

10. A fuel cell according to claim 1, wherein porosity of said anode is in the range of 20% to 50%.

11. A fuel cell according to claim 1, wherein said electrolyte electrode assembly has a circular shape, a fan shape, or a ring shape.
